(19) United States
(12) Patent Application Publication
(10) Pub. No.: US 2022/0382860 A1
(43) Pub. Date: Dec. 1, 2022

(54) DETECTING ANOMALOUS EVENTS THROUGH APPLICATION OF ANOMALY DETECTION MODELS

(71) Applicant: Microsoft Technology Licensing, LLC, Redmond, WA (US)

(72) Inventors: Itay ARGOETY, Tel Aviv (IL); Jonatan ZUKERMAN, Kiryat Ono (IL); Yasmin BOKOBZA, Ramat Gan (IL); James David MCCAFFREY, Issaquah, WA (US); Patrice GODEFROID, Mercer Island, WA (US)

(73) Assignee: Microsoft Technology Licensing, LLC, Redmond, WA (US)

(21) Appl. No.: 17/331,402

(22) Filed: May 26, 2021

(51) Int. Cl. G06F 21/55

(52) U.S. Cl. CPC G06F 21/554; G06N 3/04

(57) ABSTRACT

According to examples, an apparatus may include a processor and a memory on which is stored machine-readable instructions that when executed by the processor, may cause the processor to access a plurality of features pertaining to an event, apply an anomaly detection model on the accessed plurality of features, in which the anomaly detection model may output a reconstruction of the accessed plurality of features. The processor may calculate a reconstruction error of the reconstruction, determine whether a combination of the plurality of features is anomalous based on the calculated reconstruction error, and based on a determination that the combination of the plurality of features is anomalous, output a notification that the event is anomalous.

### BACKGROUND

Networked computing devices may generate and send data pertaining to various transactions or events to servers for logging and analysis. Organizations with large numbers of networked computing devices may generate large amounts of such data. The data may be analyzed to determine whether the computing devices may have been compromised.

### BRIEF DESCRIPTION OF DRAWINGS

Features of the present disclosure are illustrated by way of example and not limited in the following figure(s), in which like numerals indicate like elements, in which:

FIG. 1 shows a block diagram of a network environment, in which an apparatus may determine whether features pertaining to an event are anomalous and to output a notification based on a determination that the features are anomalous in accordance with an embodiment of the present disclosure;

FIG. 2 depicts a block diagram of the apparatus depicted in FIG. 1, in accordance with an embodiment of the present disclosure;

FIGS. 3 and 4A-4B, respectively, depict flow diagrams of methods for determining whether features pertaining to an event are anomalous and to output a notification based on a determination that the features are anomalous, in accordance with an embodiment of the present disclosure; and

FIG. 5 shows a block diagram of a computer-readable medium that may have stored thereon computer-readable instructions for determining whether features pertaining to an interaction event are anomalous and to output a notification based on a determination that the features are anomalous, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer-readable media in which a processor may determine whether features pertaining to an event are anomalous based on outputs from an anomaly detection model. The event may be, for instance, an interaction event with a computing device such as a log in attempt, a failed log in attempt, and/or the like. The features pertaining to the event may be other data, events and/or actions that may correspond to the event, such as, data pertaining to a geographic location at which the event occurred, an IP address of the computing device on which the event occurred, and/or the like. In some examples, the anomaly detection model may be trained using normal interaction data that may have been provided by personnel having cyber security expertise and thus, the anomaly detection model may have been trained using accurate training data.

According to examples, the anomaly detection model may be an artificial neural network such as an autoencoder that may use training data to learn codings of data. For instance, the anomaly detection model may include an encoder that may encode the inputted features into latent data (hidden layer) and a decoder that may output a reconstruction of the features from the latent data. The decoder may take a latent representation of the features as an input to reconstruct the features. The processor may determine that the features are anomalous when, for instance, there are differences between the reconstructed features and the input features. The processor may also identify which of the features are anomalous through a determination of relative reconstruction errors of the reconstructed features.

The processor may, based on a determination that the features are anomalous, output a notification that the event is anomalous. In some examples, the processor may identify the anomalous features and may output identifications of the anomalous features. As a result, an analyst may determine both that an event is anomalous and the cause for the event being determined to be anomalous.

As the collected amount of event-related data increases, the detection of anomalous events may become increasingly difficult and may result in greater numbers of false positive indications. In addition, when models that have been trained using inaccurate training data are employed to detect anomalous events, anomalous events may be overlooked and/or events that are normal may be identified as being anomalous. Through implementation of the present disclosure, anomalous events may accurately be detected through application of accurately trained anomaly detection models on the features pertaining to an event. In addition, instead of analyzing the event itself, features pertaining to the event may be analyzed to determine whether a combination of the features indicates that the event is anomalous, which may also result in more accurate determinations of anomalous events. Moreover, the features that are anomalous may be identified and identifications of those features may be outputted such that, for instance, analysts may determine causes of the events being determined to be anomalous. Technical improvements afforded through implementation of the present disclosure may thus include improved anomalous event detection, reduced false positive detections, improved anomaly causation detection, and/or the like, which may improve security across networked computing devices.

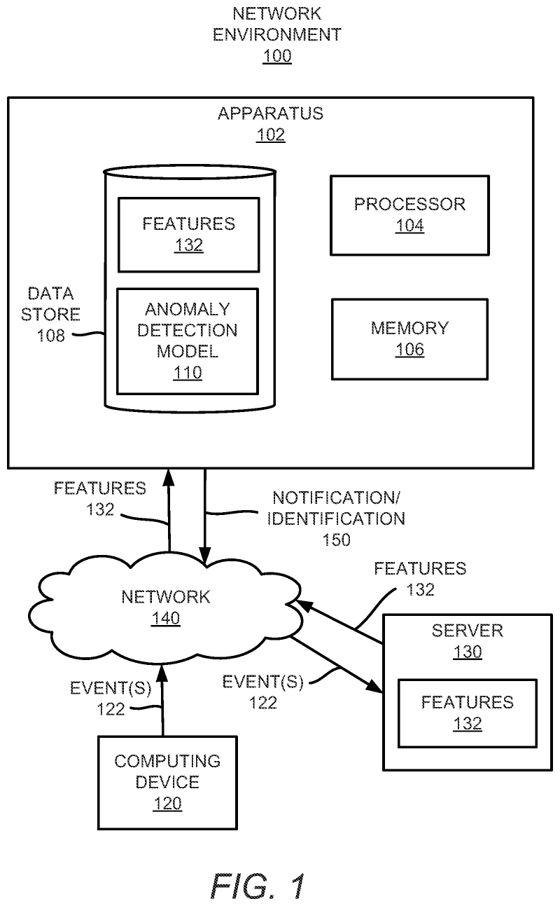

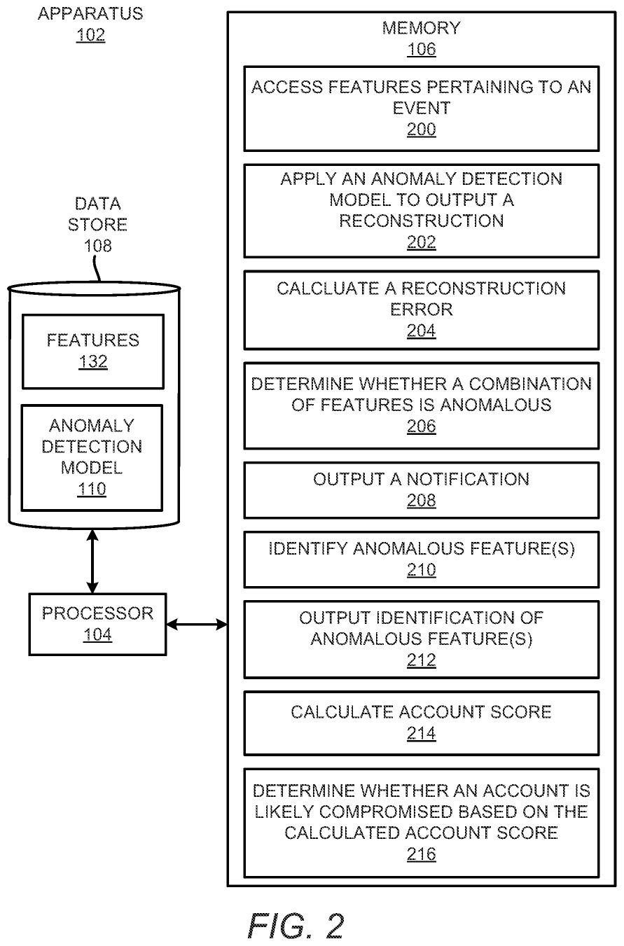

Reference is first made to FIGS. 1 and 2. FIG. 1 shows a block diagram of a network environment 100, in which an apparatus 102 may determine whether features 132 pertaining to an event 122 are anomalous and to output a notification 150 based on a determination that the features 132 are anomalous, in accordance with an embodiment of the present disclosure. FIG. 2 depicts a block diagram of the apparatus 102 depicted in FIG. 1, in accordance with an embodiment of the present disclosure. It should be understood that the network environment 100 and the apparatuses 102 may include additional features and that some of the features described herein may be removed and/or modified without departing from the scopes of the network environment 100 and/or the apparatuses 102.

As shown in FIG. 1, the network environment 100 may include the apparatus 102 and a computing device 120. The apparatus 102 may be a computing device, such as a server, a desktop computer, a laptop computer, and/or the like. The computing device 120 may be a laptop computing device, a desktop computing device, a tablet computer, a smartphone, and/or the like. The computing device 120 may communicate with a server 130, in which the server 130 may be remote from the computing device 120. In some examples, the apparatus 102 may be a computing device that an administrator, IT personnel, and/or the like, may access in, for instance, managing operations of the server 130. By way of particular example, the apparatus 102 may be a server of a cloud services provider. It should be understood that a single apparatus 102, a single computing device 120, and a single server 130 have been depicted in FIG. 1 for purposes of simplicity. Accordingly, the network environment 100 depicted in FIG. 1 may include any number of apparatuses 102, computing devices 120, and/or servers 130 without departing from a scope of the network environment 100.

The computing device 120 may communicate with the server 130 to, for instance, send data pertaining to events 122 to the server 130. As shown in FIG. 1, the computing device 120 may communicate with the server 130 via a network 140, which may be a local area network, a wide area network, the Internet, and/or the like. In some examples, the computing device 120 may be assigned to a particular account, for instance, a particular user account.

The events 122, which are also referenced herein as interaction events 122, may include events within a set of predefined events, such as a user interaction in which the user logs into the computing device 120, a user interaction in which the user enters an incorrect credential in attempting to log into the computing device 120, a user interaction in which the user attempts to make an administrative change on the computing device 120, a user interaction in which the user attempts to access another computing device through the computing device 120, and/or the like. The predefined events may be user-defined, for instance, by an administrator, an IT personnel, and/or the like, and the computing device 120 in the instructed to gather and output data pertaining to the events within the set of predefined events. In some examples, the computing device 120 may generate the data each time such an event 122 is determined to have occurred on the computing device 120. In addition, the computing device 120 may send the data pertaining to the events 122 to the server 130 as the data is generated or may send the data as batches at certain times.

The server 130 may determine features 132 pertaining to an event 122 received from the computing device 120. The features 132 pertaining to the event 122 may include data directly corresponding to the event 122 and data indirectly corresponding to the event 122. The data directly corresponding to the event 122 may include data pertaining to any of the user interactions discussed above, e.g., incorrect entry of user credentials. The data indirectly corresponding to the event 122 may include data that may be peripheral to the event 122. Examples of the indirect data may include an IP address of the computing device 120, a geographic location of the computing device 120, a geographic location of a user account corresponding to the event 122, normal work hours of an account owner, IP addresses of gateways through which the computing device 120 normally communicates, IP addresses of servers with which the computing device 120 normally communicates, and/or the like. Additional examples of the indirect data may include whether the user's peers have committed this action in the past, e.g., whether they have accessed that resource, connected from a specific country, and/or the like, whether the resource and/or the country is popular in the organization, and/or the like.

The server 130 may determine the features 132 through any of a number of suitable manners. For instance, the server 130 may access one or more logs that may include the indirect data to determine the features 132. The server 130 may also or alternatively, access other sources of information for the features 132, such as other servers, databases, user inputs, and/or the like.

As also shown in FIG. 1, the server 130 may communicate the determined features 132 to the apparatus 102 via the network 140. In some instances, the features 132 may be construed as low fidelity signals because the features 132 pertaining to the event 122, which may include data pertaining to the event 122, themselves may not be construed as being anomalous. In other words, an analyst analyzing the features 132 alone may not determine that the features 132 are anomalous.

As shown in FIGS. 1 and 2, the apparatus 102 may include a processor 104 that may control operations of the apparatus 102. The apparatus 102 may also include a memory 106 on which data that the processor 104 may access and/or may execute may be stored. The processor 104 may be a semiconductor-based microprocessor, a central processing unit (CPU), an application specific integrated circuit (ASIC), a field-programmable gate array (FPGA), and/or other hardware device. The memory 106, which may also be termed a computer readable medium, may be, for example, a Random Access memory (RAM), an Electrically Erasable Programmable Read-Only Memory (EEPROM), a storage device, or the like. The memory 106 may be a non-transitory computer readable storage medium, where the term “non-transitory” does not encompass transitory propagating signals. In any regard, the memory 106 may have stored thereon machine-readable instructions that the processor 104 may execute.

Although the apparatus 102 is depicted as having a single processor 104, it should be understood that the apparatus 102 may include additional processors and/or cores without departing from a scope of the apparatus 102. In this regard, references to a single processor 104 as well as to a single memory 106 may be understood to additionally or alternatively pertain to multiple processors 104 and multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 may be distributed across multiple apparatuses 102 and/or multiple processors 104.

As shown in FIG. 2, the memory 106 may have stored thereon machine-readable instructions 200-216 that the processor 104 may execute. Although the instructions 200-216 are described herein as being stored on the memory 106 and may thus include a set of machine-readable instructions, the apparatus 102 may include hardware logic blocks that may perform functions similar to the instructions 200-216. For instance, the processor 104 may include hardware components that may execute the instructions 200-216. In other examples, the apparatus 102 may include a combination of instructions and hardware logic blocks to implement or execute functions corresponding to the instructions 200-216. In any of these examples, the processor 104 may implement the hardware logic blocks and/or execute the instructions 200-216. As discussed herein, the apparatus 102 may also include additional instructions and/or hardware logic blocks such that the processor 104 may execute operations in addition to or in place of those discussed above with respect to FIG. 2.

The processor 104 may execute the instructions 200 to access a plurality of features 132 pertaining to an event 122. As discussed herein, the processor 104 may receive the features 132 from the server 130. The processor 104 may also store the received features 132 in a data store 108, which may be a Random Access memory (RAM), an Electrically Erasable Programmable Read-Only Memory (EEPROM), a storage device, or the like. The processor 104 may access the features 132 from the data store 108. In other examples, the processor 104 may stream the features 132 from the server 130.

The processor 104 may execute the instructions 202 to apply an anomaly detection model 110 on the accessed plurality of features 132. The anomaly detection model 110 may output a reconstruction of the accessed plurality of features 132. By way of particular example, the anomaly detection model 110 may be an artificial neural network such as autoencoder that may use training data to learn codings of data. For instance, the anomaly detection model 110 may include an encoder that may encode the features 132 into latent data (hidden layer) and a decoder that may output a reconstruction of the features 132 from the latent data. The decoder may take a latent representation of the features 132 as an input to reconstruct the features 132.

The anomaly detection model 110 maybe trained using training data collected from, for instance, personnel with cyber security expertise within an organization. The anomaly detection model 110 may learn the latent representation of the training data. According to examples, the personnel with the cyber security expertise may provide the training data through a portal or in any other suitable manner. In addition, the processor 104 or a processor of another computing device may train the anomaly detection model 110. In one regard, the anomaly detection model 110 may accurately model normal activities of the features through use of the accurate training data. The normal activities may be those activities that are known to not be associated with malicious behavior, for instance.

As noted herein, application of the anomaly detection model 110 may result in an output of a reconstruction of the features 132. The processor 104 may execute the instructions 204 to calculate a reconstruction error of the reconstruction. That is, the processor 104 may calculate a difference between the reconstruction of the features 132 and the inputted version of the features 132, in which the difference may correspond to the reconstruction error. According to examples, the input features 132 may be represented by the vector value X, in which X=[x₁, x₂, x₃ . . . xₙ]. The input features 132 may be features that may have been collected during a predetermined time period. The predetermined time period may be user-defined and may be, for instance, hours, days, weeks, etc. In addition, the processor 104 may calculate the vector value X per account. The output features in the reconstruction may be represented as a vector d(e(x))=[\hat{x}₁, \hat{x}₂, \hat{x}₃ . . . \hat{x}ₙ].

By way of example, the processor 104 may calculate the reconstruction error as:

Reconstruction error=|xᵢ−\hat{x}ᵢ| Equation (1):

In Equation (1), xᵢ may represent the input features 132 and \hat{x}ᵢ may represent the reconstruction of the features 132.

The processor 104 may execute the instructions 206 to determine whether a combination of the plurality of features 132 is anomalous based on the calculated reconstruction error. For instance, the processor 104 may determine that a combination of the features 132 is anomalous when there is a reconstruction error, e.g., when the reconstruction error is greater than zero. As other examples, the processor 104 may determine whether the reconstruction error exceeds a predefined value and may determine that a combination of the features 132 is anomalous based on the reconstruction error exceeding the predefined value. The predefined value may be user-defined, may be based on an accuracy of the anomaly detection model 110, and/or the like.

According to examples, the processor 104 may calculate an anomaly score from the calculated reconstruction error. For instance, the processor 104 may calculate the anomaly score as a mean squared error according to the following equation:

$$Anomaly score = \frac{1}{n} \times {\sum }_{\dot{i} = 1}^{n} {( {x}_{i} - {\hat{x}}_{i} )}^{2} \qquad Equation ( 2 )$$

The processor 104 may also determine whether the anomaly score exceeds a predefined value, which may be user defined. In addition, based on a determination that the anomaly score exceeds the predefined value, the processor 104 may determine that an account associated with the event 122 is likely compromised. The account associated with the event 122 may be a user account that was used to access the computing device 120.

According to examples, the processor 104 may calculate a plurality of anomaly scores from the calculated reconstruction error over windows of time, e.g., a certain number of hours, a certain number of days, etc. In addition, the processor 104 may determine an account score for a time window in the windows of time, determine whether the account score exceeds a predefined score, and based on a determination that the account score exceeds the predefined score, determine that an account associated with the event is likely compromised.

The processor 104 may execute the instructions 208 to, based on a determination that the combination of the plurality of features 132 is anomalous, output a notification 150 that the event 122 is anomalous. The processor 104 may also output the notification 150 to indicate that the account associated with the event is likely compromised. The processor 104 may output the notification 150 to an administrator of an organization within which a user of the computing device 120 may be a member. In addition, or alternatively, the processor 104 may output the notification 150 to an administrator, IT personnel, analyst, and/or the like, such that the event 122 may be further analyzed to determine whether the event 122 is potentially malicious.

According to examples, the processor 104 may execute the instructions 210 to identify one or more anomalous features 132. For instance, the anomaly detection model 110 may output a reconstruction for each of the features 132 in the plurality of features and the processor 104 may calculate respective reconstruction error values of the features 132 from the respective reconstructions. According to examples, the processor 104 may calculate relative reconstruction errors of each of the features according to the following equation:

$$Relative reconstruction error = \vert \frac{( {x}_{i} - {\hat{x}}_{i} )}{{x}_{i}} \vert \qquad Equation ( 3 )$$

In addition, the processor 104 may identify a feature of the plurality of features 132 that is anomalous based on the calculated reconstruction error values. For instance, the processor 104 may identify the features 132 having reconstruction error values (e.g., relative reconstruction errors) that are greater than a predefined value, e.g., greater than zero. In some instances, the processor 104 may identify a set of the features that are anomalous based on the calculated reconstruction error values, in which the set of the features corresponds to a predefined number of anomalous features. The predefined number of anomalous features may be user defined and may correspond to, for instance, the three or five features having the greatest reconstruction error values.

The processor 104 may also execute the instructions 212 to output an identification of the identified feature or identifications of the identified features. In this regard, the processor 104 may output the identifications of the features that are deemed to be anomalous, which an analyst may use to determine a justification for the determination that the event 122 is anomalous.

By way of particular example, the event 122 may be a log in attempt onto a user account through the computing device 120 and a feature 132 may be a geographic location of the computing device 120 when the log in attempt occurred. In this example, the reconstruction of the feature 132 outputted by the anomaly detection model 110 may differ from the feature 132 in instances in which the geographic location of the computing device 120 is abnormal. For instance, a normal geographic location of the computing device 120 may be the United States and thus, if the geographic location is Germany, the processor 104 may determine that the feature 132 and thus, the event 122, is anomalous.

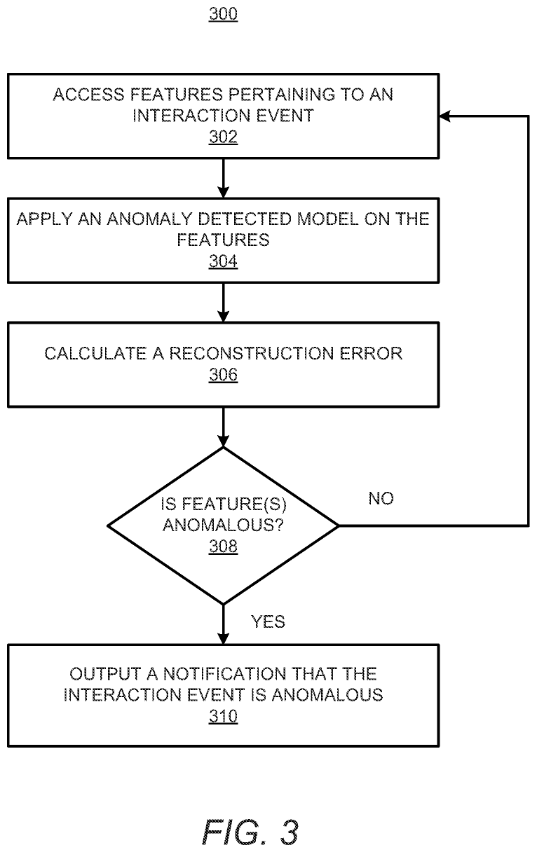

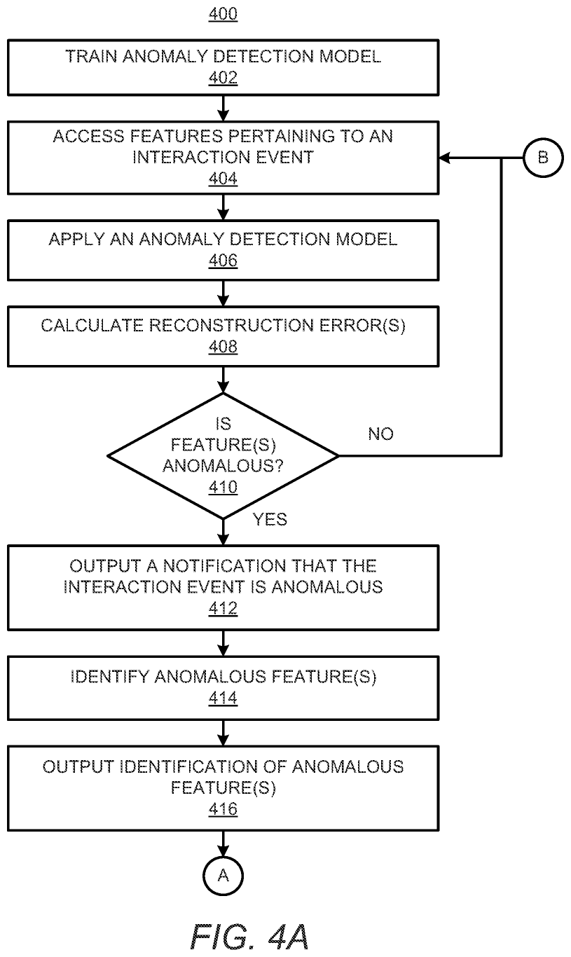

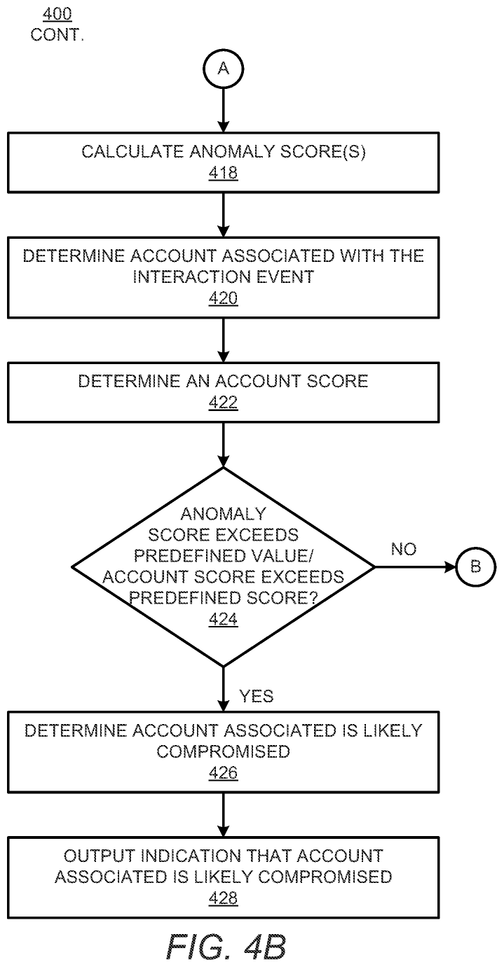

Various manners in which the processor 104 of the apparatus 102 may operate are discussed in greater detail with respect to the methods 300 and 400 depicted in FIGS. 3 and 4. Particularly, FIGS. 3 and 4A-4B, respectively, depict flow diagrams of methods 300, 400 for determining whether features 132 pertaining to an event 122 are anomalous and to output a notification 150 based on a determination that the features 132 are anomalous, in accordance with an embodiment of the present disclosure. It should be understood that the methods 300 and 400 may include additional operations and that some of the operations described therein may be removed and/or modified without departing from the scopes of the methods 300 and 400. The descriptions of the methods 300 and 400 are made with reference to the features depicted in FIGS. 1 and 2 for purposes of illustration.

With reference first to FIG. 3, at block 302, the processor 104 may access a plurality of features 132 pertaining to an interaction event 122 on a computing device 120. As discussed herein, a server 130 may determine the features 132 pertaining to the interaction event 122 and may communicate the determined features 132 to the apparatus 102. The processor 104 may store the features 132 in a data store 108 and may access the features 132 from the data store 108.

At block 304, the processor 104 may apply an anomaly detection model 110 on the accessed plurality of features 132. As discussed herein, the anomaly detection model 110 may encode the plurality of features 132 into latent data and may output a reconstruction of the plurality of features 132 from the latent data.

At block 306, the processor 104 may calculate a reconstruction error based on a difference between the reconstruction of the plurality of features 132 and the plurality of features 132. At block 308, the processor 104 may determine whether at least one of the plurality of features 132 is anomalous based on the calculated reconstruction error. For instance, the processor 104 may determine whether one or more of the reconstructions of the features 132 are different from the respective features 132. The processor 104 may determine that a feature is anomalous based on the reconstruction of the feature being different from the feature.

Based on a determination that none of the features are anomalous at block 308, the processor 104 may repeat blocks 302-308 on another set of features 132. However, based on a determination that at least one of the plurality of features is anomalous, at block 310, the processor 104 may output a notification that the interaction event 122 is anomalous.

With reference now to FIGS. 4A-4B, at block 402, the processor 104 may train an anomaly detection model 110 with training data corresponding to normal activities of the features 132. The training data may be data collected from cyber security experts.

At block 404, the processor 104 may access a plurality of features 132 pertaining to an interaction event 122 on a computing device 120. At block 406, the processor 104 may apply the anomaly detection model 110 on the accessed plurality of features 132, in which the anomaly detection model 110 may encode the plurality of features 132 into latent data and may output a one or more reconstructions of the plurality of features 132 from the latent data. At block 408, the processor 104 may calculate one or more reconstruction errors based on one or more differences between the reconstructions of the plurality of features and the plurality of features 132.

At block 410, the processor 104 may determine whether at least one of the plurality of features 132 is anomalous based on the calculated reconstruction errors. Based on a determination that none of the features 132 are anomalous, the processor 104 may repeat blocks 404-410 on another set of features 132. However, based on a determination that at least one of the features 132 is anomalous, the processor 104 may, at block 412, output a notification 150 that the interaction event 122 is anomalous.

At block 414, the processor 104 may identify one or more anomalous features 132. As discussed herein, the processor 104 may identify the one or more anomalous features 132 based on relative reconstruction errors of the features. In addition, at block 416, the processor 104 may output an identification of the identified anomalous features.

According to examples, at block 418, the processor 104 may calculate one or more anomaly scores from the calculated reconstruction error(s). for instance, the processor 104 may calculate a plurality of anomaly scores from the calculated reconstruction errors over windows of time. The processor 104 may also, at block 420, determine an account associated with the interaction event 122.

In some examples, at block 422, the processor 104 may determine an account score for a time window in the windows of time. At block 424, the processor 104 may determine whether the account score exceeds a predefined score and/or the anomaly score exceeds a predefined score. Based on the account score not exceeding the predefined score and/or the anomaly score not exceeding the predefined score, the processor 104 may repeat blocks 404-424 on another set of features 132. However, based on a determination that the account score exceeds the predefined score and/or the anomaly score exceeds the predefined score, at block 426, the processor 104 may determine that an account associated with the interaction event 122 is likely compromised. In addition, at block 428, the processor 104 may output an indication that the account associated with the interaction event 122 is likely compromised.

Some or all of the operations set forth in the methods 300, 400 may be included as utilities, programs, or subprograms, in any desired computer accessible medium. In addition, the methods 300, 400 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

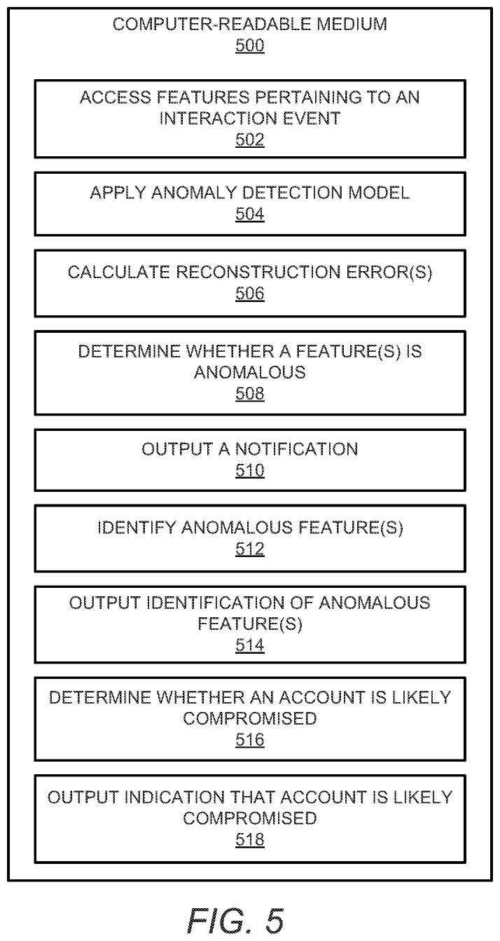

Turning now to FIG. 5, there is shown a block diagram of a computer-readable medium 500 that may have stored thereon computer-readable instructions for determining whether features 132 pertaining to an interaction event 122 are anomalous and to output a notification 150 based on a determination that the features 132 are anomalous, in accordance with an embodiment of the present disclosure. It should be understood that the computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium, in which the term “non-transitory” does not encompass transitory propagating signals.

The computer-readable medium 500 may have stored thereon computer-readable instructions 502-518 that a processor, such as a processor 104 of the apparatus 102 depicted in FIGS. 1 and 2, may execute. The computer-readable medium 500 may be an electronic, magnetic, optical, or other physical storage device that contains or stores executable instructions. The computer-readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to access a plurality of features 132 pertaining to an interaction event 122 on a computing device 120. The processor may fetch, decode, and execute the instructions 504 to apply an anomaly detection model on the accessed plurality of features 132, in which the anomaly detection model 110 may encode the plurality of features 132 into latent data and output a reconstruction of the plurality of features from the latent data. The processor may fetch, decode, and execute the instructions 506 to calculate a reconstruction error based on a difference between the reconstruction of the plurality of features and the plurality of features 132. The processor may fetch, decode, and execute the instructions 508 to determine whether at least one of the plurality of features 132 is anomalous based on the calculated reconstruction error. In addition, the processor The processor may fetch, decode, and execute the instructions 510, based on a determination that at least one of the plurality of features 132 is anomalous, output a notification 150 that the interaction event 122 is anomalous.

As discussed herein, the anomaly detection model 110 may output a reconstruction for each of the features in the plurality of features. In addition, the processor may fetch, decode, and execute the instructions 512 to identify anomalous features. For instance, the processor may calculate respective reconstruction error values of the features from the respective reconstructions and may identify a feature of the plurality of features that is anomalous based on the calculated reconstruction error values. The processor may fetch, decode, and execute the instructions 514 to output an identification of the identified feature.

According to examples, the processor may fetch, decode, and execute the instructions 516 to determine whether an account is likely compromised. For instance, the processor may calculate an anomaly score from the calculated reconstruction error, determine whether the anomaly score exceeds a predefined value, and based on a determination that the anomaly score exceeds the predefined value, determine that an account associated with the event is likely compromised. In addition, or alternatively, the processor may calculate a plurality of anomaly scores from the calculated reconstruction error over windows of time, determine an account score for a time window in the windows of time, determine whether the account score exceeds a predefined score, and based on a determination that the account score exceeds the predefined score, determine that an account associated with the event is likely compromised. The processor may also fetch, decode, and execute the instructions 518 to output an indication that the account is likely compromised.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
access a plurality of features pertaining to an event;
apply an anomaly detection model on the accessed plurality of features, wherein the anomaly detection model is to output a reconstruction of the accessed plurality of features;
calculate a reconstruction error of the reconstruction;
determine whether a combination of the plurality of features is anomalous based on the calculated reconstruction error; and
based on a determination that the combination of the plurality of features is anomalous, output a notification that the event is anomalous.

2. The apparatus of claim 1, wherein the anomaly detection model is to output a reconstruction for each of the features in the plurality of features and wherein the instructions cause the processor to:
calculate respective reconstruction error values of the features from the respective reconstructions;
identify a feature of the plurality of features that is anomalous based on the calculated reconstruction error values; and
output an identification of the identified feature.

3. The apparatus of claim 1, wherein the anomaly detection model is to output a reconstruction for each of the features in the plurality of features and wherein the instructions cause the processor to:
calculate respective reconstruction error values of the features from the respective reconstructions;
identify a set of the features that are anomalous based on the calculated reconstruction error values, wherein the set of the features corresponds to a predefined number of anomalous features; and
output identifications of the identified set of the features.

4. The apparatus of claim 1, wherein the plurality of features pertaining to the event comprise data directly corresponding to the event and data indirectly corresponding to the event.

5. The apparatus of claim 1, wherein the plurality of features correspond to data collected during a predetermined period of time.

6. The apparatus of claim 1, wherein the instructions cause the processor to:
calculate an anomaly score from the calculated reconstruction error;
determine whether the anomaly score exceeds a predefined value; and
based on a determination that the anomaly score exceeds the predefined value, determine that an account associated with the event is likely compromised.

7. The apparatus of claim 6, wherein the instructions cause the processor to:
calculate a mean square error of the calculated reconstruction error to calculate the anomaly score.

8. The apparatus of claim 1, wherein the instructions cause the processor to:
calculate a plurality of anomaly scores from the calculated reconstruction error over windows of time;
determine an account score for a time window in the windows of time;
determine whether the account score exceeds a predefined score; and
based on a determination that the account score exceeds the predefined score, determine that an account associated with the event is likely compromised.

9. The apparatus of claim 1, wherein the instructions cause the processor to:
train the anomaly detection model with training data corresponding to normal activities of the features.

10. A method comprising:
accessing, by a processor, a plurality of features pertaining to an interaction event on a computing device;
applying, by the processor, an anomaly detection model on the accessed plurality of features, wherein the anomaly detection model is to encode the plurality of features into latent data and to output a reconstruction of the plurality of features from the latent data;
calculating, by the processor, a reconstruction error based on a difference between the reconstruction of the plurality of features and the plurality of features;
determining, by the processor, whether at least one of the plurality of features is anomalous based on the calculated reconstruction error; and
based on a determination that at least one of the plurality of features is anomalous, outputting a notification that the interaction event is anomalous.

11. The method of claim 10, wherein the anomaly detection model is to output a reconstruction for each of the features in the plurality of features, the method further comprising:
calculating respective reconstruction error values of the features from the respective reconstructions;
identifying a feature of the plurality of features that is anomalous based on the calculated reconstruction error values; and
outputting an identification of the identified feature.

12. The method of claim 10, wherein the anomaly detection model is to output a reconstruction for each of the features in the plurality of features, the method further comprising:
calculating respective reconstruction error values of the features from the respective reconstructions;
identifying a set of the features that are anomalous based on the calculated reconstruction error values, wherein the set of the features corresponds to a predefined number of anomalous features; and
outputting identifications of the identified set of the features.

13. The method of claim 10, further comprising:
calculating an anomaly score from the calculated reconstruction error;
determining whether the anomaly score exceeds a predefined value; and
based on a determination that the anomaly score exceeds the predefined value, determining that an account associated with the interaction event is likely compromised.

14. The method of claim 10, further comprising:
calculating a plurality of anomaly scores from the calculated reconstruction errors over windows of time;
determining an account score for a time window in the windows of time;
determining whether the account score exceeds a predefined score; and
based on a determination that the account score exceeds the predefined score, determining that an account associated with the event is likely compromised.

15. The method of claim 10, further comprising:
training the anomaly detection model with training data corresponding to normal activities of the features.

16. The method of claim 10, wherein the plurality of features pertaining to the event comprise data directly corresponding to the event and data indirectly corresponding to the event.

17. A computer-readable medium on which is stored computer-readable instructions that when executed by a processor, cause the processor to:
access a plurality of features pertaining to an interaction event on a computing device;
apply an anomaly detection model on the accessed plurality of features, wherein the anomaly detection model is to encode the plurality of features into latent data and to output a reconstruction of the plurality of features from the latent data;
calculate a reconstruction error based on a difference between the reconstruction of the plurality of features and the plurality of features;
determine whether at least one of the plurality of features is anomalous based on the calculated reconstruction error; and
based on a determination that at least one of the plurality of features is anomalous, output a notification that the interaction event is anomalous.

18. The computer-readable medium of claim 17, wherein the anomaly detection model is to output a reconstruction for each of the features in the plurality of features, and wherein the instructions further cause the processor to:
calculate respective reconstruction error values of the features from the respective reconstructions;
identify a feature of the plurality of features that is anomalous based on the calculated reconstruction error values; and
output an identification of the identified feature.

19. The computer-readable medium of claim 17, wherein the instructions further cause the processor to:
calculate an anomaly score from the calculated reconstruction error;
determine whether the anomaly score exceeds a predefined value; and
based on a determination that the anomaly score exceeds the predefined value, determine that an account associated with the event is likely compromised.

20. The computer-readable medium of claim 17, wherein the instructions further cause the processor to:
calculate a plurality of anomaly scores from the calculated reconstruction error over windows of time;
determine an account score for a time window in the windows of time;
determine whether the account score exceeds a predefined score; and
based on a determination that the account score exceeds the predefined score, determine that an account associated with the event is likely compromised.
